(19) United States
(12) Patent Application Publication
(10) Pub. No.: US 2018/0042071 A1
(43) Pub. Date: Feb. 8, 2018

(54) HEATABLE MEDIA GUIDE AND METHOD FOR MANUFACTURING A HEATABLE MEDIA GUIDE

(71) Applicant: LEONI KABEL GMBH, NUERNBERG (DE)

(72) Inventors: THOMAS DAMEROW, PLEINFELD (DE); CHRISTIAN ERNST, WEISSENBURG (DE); ALEXANDER JUNGER, GEORGENSGMUEND (DE); FRANK LAEMMER, AUGSBURG (DE)

(21) Appl. No.: 15/666,616

(22) Filed: Aug. 2, 2017

(30) Foreign Application Priority Data
Aug. 3, 2016 (DE) 10 2016 214 395.6

(51) Int. Cl. H05B 3/58

(52) U.S. Cl. CPC H05B 3/58; H05B 2203/017; H05B 2203/021; H05B 2203/022; B29C 47/0026

(57) ABSTRACT

A heatable media guide serves for guiding a medium. It has a tubular guide element which extends in a longitudinal direction and has a sheathing made from a sheathing material, which surrounds an interior space for the medium. The guide element furthermore has at least one heating element, which extends with the sheathing in the longitudinal direction and which is embedded in the sheathing material.

### CROSS-REFERENCE TO RELATED APPLICATION

This application claims the priority, under 35 U.S.C. §119, of German application DE 10 2016 214 395.6, filed Aug. 3, 2016; the prior application is herewith incorporated by reference in its entirety.

### BACKGROUND OF THE INVENTION

### Field of the Invention

The invention relates to a heatable media guide for guiding a medium and a method for manufacturing a heatable media guide of this type.

Heatable media guides of this type serve for warming or tempering gaseous or liquid fluids inside an often hose-shaped line. To heat the medium (fluid), a heating element can be used which is wound for example around the outside of the hose-like guide element. However the sheathing of the guide element here acts as an insulator. Also, manufacture is normally complex.

As an alternative to this, the heating element can also be guided inside the guide element. Problems sometimes arise here if the medium to be conveyed is an aggressive medium which may attack the heating element. Production is also comparatively complex in this case.

### SUMMARY OF THE INVENTION

Taking this as a starting point, the object of the invention is to provide a heatable media guide which is simple to manufacture.

The heatable media guide serves in general for guiding a medium, in particular a gaseous or liquid fluid. It has a tubular guide element which extends in a longitudinal direction and is formed in particular as a preferably flexible hose. The guide element has a sheathing made from a sheathing material, which surrounds an interior space for the medium. The guide element therefore serves for guiding the medium and the medium flows through it in normal use. Additionally, the media guide further has a heating element which extends together with the sheathing in the longitudinal direction. The heating element here is, in particular, a heating wire, either an uninsulated heating wire or a heating wire surrounded by an insulating sheathing. Where heating wire is mentioned here, this refers to both an individual solid wire and also a bundle of individual wires. In the case of the media guide, the heating element, i.e. especially the heating wire, is here embedded in the sheathing material of the sheathing. In normal use, the medium is tempered, in particular heated, via the heating element.

In terms of the manufacturing technology, the procedure here is such that the sheathing of the guide element is manufactured by extrusion and, during this extrusion process, the heating element is, at the same time, also supplied and surrounded by the extrusion mass which at the same time forms the sheathing material.

Overall, as a result of this measure, a particularly simple manufacturing process is therefore achieved, in which the heating element is also integrated “in-line”, as it were, during the manufacture of the sheathing of the tubular guide element. An additional process step for mounting the heating element on the guide element is therefore omitted.

Where “tubular” is mentioned here, this refers in particular to a channel which is completely closed circumferentially, preferably with a circular cross section. However, other cross-sectional shapes are also fundamentally possible. The guide element here has, in particular, a constant wall thickness. The guide element here is preferably annular in form. The term annular means in particular having the shape of a circular ring. As an alternative to a circular design of the annular guide element, the guide element is formed in the shape of an oval or as a rectangle.

According to a first variant embodiment, the heating element is expediently embedded directly in the tubular or hose-shaped sheathing. The heating element is therefore a direct component of the sheathing, which especially has a constant wall thickness over its circumference. As a result—compared to an outside arrangement of the heating element—an improved heat transfer into the interior space of the guide element is achieved since there is less sheathing material between the heating element and the interior space.

In a preferred embodiment, it is furthermore provided that the sheathing has an inner sheathing layer and an outer sheathing layer, wherein the latter has a greater thermal insulating effect compared to the inner sheathing layer. The outer sheathing layer therefore serves to insulate the guide element to the outside. The thermal losses of the medium flowing in the interior space are thereby reduced.

The improved or greater insulating effect in the outer sheathing layer is preferably achieved by a higher gas or air content compared to the inner sheathing layer.

According to a first variant, the outer sheathing layer is a foamed sheathing layer, i.e. a sheathing layer which has a lower density than the inner sheathing layer, and/or it is a sheathing layer having a multiplicity of air pockets.

As an alternative to forming the outer sheathing layer as a foamed sheathing layer, or in addition to this, hollow chambers are incorporated in the outer sheathing layer. These are, in particular, hollow channels extending continuously in the longitudinal direction. In terms of the manufacturing technology, this can be implemented in a simple manner during the extrusion.

In the embodiment having the two sheathing layers, the heating element is arranged in the inner sheathing layer in a preferred embodiment. On the one hand, this promotes the introduction of heat into the interior space and into the medium and, at the same time, thermal losses to the outside are substantially prevented.

In this variant embodiment having the two sheathing layers, the two sheathing layers are preferably made from the same plastics material. Alternatively, the outer sheathing layer is made from a different plastics material, for example from a polyolefin (PE, PP etc). Especially with this multi-layer design, the sheathing here is formed in a single extrusion step by co-extrusion.

According to a second preferred fundamental embodiment, the heating element is arranged outside the sheathing but still embedded in the sheathing material. The heating element, especially the heating wire, is guided along the outside surface of the, in particular, annular sheathing, which preferably has a constant wall thickness. At the same time, the heating element is embedded in the sheathing material.

During the extrusion, the sheathing material also forms, in addition to the sheathing, further regions outside the actual sheathing. Therefore, the sheathing material does not only form the sheathing. Instead, further portions are formed by the sheathing material, which are integrally connected to the sheathing and inside of which the heating element is embedded in the sheathing material. As a consequence of the common extrusion, the sheathing and this at least one further region form a single-piece extruded component, in particular an extruded profiled strand. In addition to the sheathing, this profiled strand therefore further has at least one further region in which the heating element is embedded.

In the second embodiment having the arrangement of the heating element outside the sheathing, the heating element is preferably covered by a sheathing skin made from the sheathing material, wherein this sheathing skin is formed in the manner of a protrusion on the, for example, annular sheathing material. The heating element is embedded between the outside of the sheathing and the inside of the sheathing skin. The heating element here preferably abuts directly against an outside of the sheathing. As seen in cross section, the guide element is for example formed in the shape of an eight. The one circular half of the eight here is considerably larger than the other and forms the tubular guide element. The second circular half of the eight here is considerably smaller and, to all intents and purposes, defines the heating element embedded between the sheathing and the sheathing skin. The heating element here is guided preferably helically along the outside of the sheathing.

According to a third fundamental variant embodiment, the heating element is preferably arranged in the interior space, wherein the heating element is connected to the sheathing via the sheathing material and is thereby also fixed to the sheathing. Overall, the heating element is also supplied during the extrusion procedure in this variant, but in this case extending inwards in the interior space. In a manner similar to that of the second variant embodiment, a profiled strand is therefore formed from the sheathing material, now with a region in the interior space of the sheathing.

It is provided here, for example, that the heating element is arranged directly on the inside of an inner wall of the sheathing, for example extending helically, as has also been described previously for the variant on the outer wall. Particularly good introduction of heat and thermal insulation to the outside is achieved with the embodiment on the inner wall.

The heating element here is preferably connected to the sheathing by at least one strut, which extends in the radial direction. The strut here is likewise made from the sheathing material and is therefore extruded with the sheathing. The strut therefore extends continuously over the entire length of the guide element. The heating element is held at a spacing from the sheathing by the strut. The heating element here is expediently held at least substantially, and preferably precisely, centrally in the interior space. The heating element therefore extends in particular concentrically to a center axis of the guide element. This center axis at the same time normally forms a neutral fiber of the guide element. Therefore, in the event of bending stresses, the heating element generally experiences no bending stresses or only slight bending stresses.

In a preferred embodiment, the different variants described here, having the arrangement of the heating element in the different regions, namely inside the sheathing, outside the sheathing and in the interior space of the sheathing, are combined with one another in any combinations, i.e. a plurality of heating elements are embedded, wherein the heating elements are arranged in at least two of these regions.

A heatable media guide of this type is used according to the invention for conveying a medium inside the media guide, wherein the medium is heated by the heating element. The medium is preferably heated to a specified temperature here. For tempering, a regulating device with temperature measurement and control of the heating element is provided here in particular to achieve or maintain the desired specified temperature.

According to a first variant embodiment, the medium is preferably a reduction agent, in particular a urea solution. The reduction agent here is preferably supplied to a catalytic converter, especially to a catalytic converter for exhaust gas treatment. The reduction agent is especially used for so-called selective catalytic reduction (SCR process) and therefore for nitrogen oxide reduction. This is increasingly used in particular for exhaust gas treatment especially in motor vehicles. The media guide described can fundamentally also be used for other applications.

A further example is, for example, the tempering of masses, for example in the food industry, to give the mass a defined viscosity. The mass refers, for example, to chocolate.

Especially when using aggressive fluids or media, suitable base materials are used for the sheathing material. This refers in particular to fluorinated plastics materials or polyamide-based plastics materials. In particular, high-temperature materials are generally used.

Other features which are considered as characteristic for the invention are set forth in the appended claims.

Although the invention is illustrated and described herein as embodied in a heatable media guide and a method for manufacturing a heatable media guide, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view through a heatable media guide, in which a heating element is embedded directly in an annular sheathing and according to the invention;

FIG. 2 is a cross-sectional view of the media guide, wherein, starting from the variant according to FIG. 1, a further outer foamed sheathing layer is additionally provided;

FIG. 3 is a cross-sectional view of the media guide according to a further variant embodiment, in which an outer sheathing layer is provided with a multiplicity of hollow channels;

FIG. 4 is a cross-sectional view of a further variant embodiment, in which the heating element is arranged on the outside of the sheathing; and

FIG. 5 is a cross-sectional view of a further variant embodiment, in which the heating element is arranged extending in the interior space.

### DETAILED DESCRIPTION OF THE INVENTION

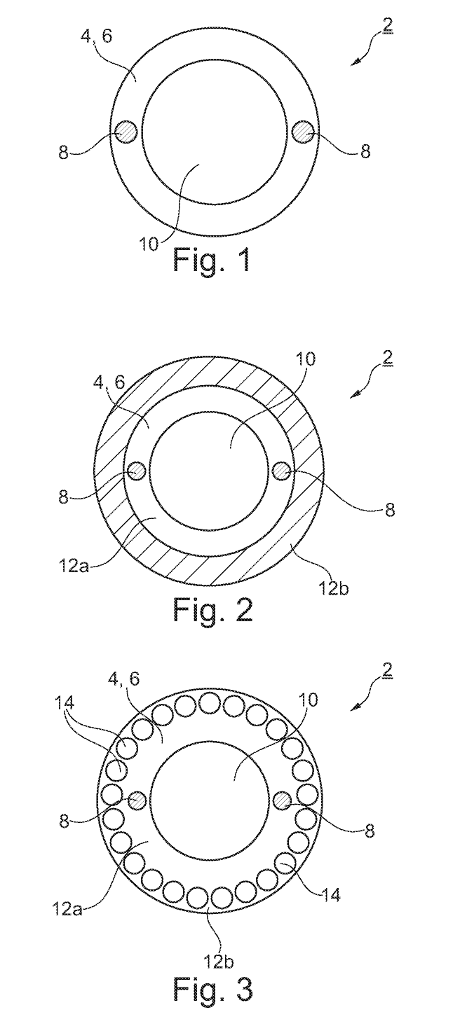

FIGS. 1-5 each show simplified cross-sectional illustrations of a heatable media guide 2. All of the media guides 2 here have a hose-like guide element 4 which is formed by an annular sheathing 6 with an, in particular, constant wall thickness. The media guide 2 furthermore has at least one heating element 8, which is formed in all of the exemplary embodiments as a heating wire. This is optionally a solid wire or also a stranded wire.

The guide element and the sheathing 6 here are generally hose-shaped structures which extend in a longitudinal direction aligned perpendicularly to the plane of the paper. The media guide 2 here extends typically over at least some 10 cm or over several meters. At the end, a coupling element, by which the media guide 2 can be connected to a connection of a housing or component, is arranged on the media guide 2 in a manner not illustrated here in more detail. The coupling element is, for example, a plug-type coupling element. At the same time, the at least one heating element 8 is expediently also electrically contacted via the coupling element. To this end, the heating element 8 is therefore optionally separate from the sheathing 6 or contacted inside the sheathing and connected via a line to a control and supply unit for supplying the heating element 8 with electrical energy. The heating element 8 is generally an electric resistance heater.

In all of the variant embodiments, there is fundamentally the option of arranging a plurality of heating elements 8, for example 2, 3, 4, 6 or more heating elements 8, distributed around the circumference, and preferably distributed uniformly. In the exemplary embodiments of FIGS. 1 to 3, for example, two heating elements 8 are shown in each case.

In the variant embodiment according to FIG. 1, these are integrated directly in the sheathing 6.

In the variant embodiment according to FIG. 2, the sheathing 6 is formed in two layers with an inner sheathing layer 12a and an outer sheathing layer 12b. The inner sheathing layer 12a here is preferably constructed identically to the sheathing 6 described in FIG. 1. The outer sheathing layer 12b is, in particular, an insulating layer having an improved thermal insulating effect compared to the inner sheathing layer 12a. The outer sheathing layer 12b is especially a foamed sheathing layer.

As an alternative to this, with a correspondingly large wall thickness of the sheathing 6, there is also fundamentally the option of not arranging the heating elements 8 centrally, but oriented towards the interior space 10.

In the variant embodiment of FIG. 3, the sheathing 6 is in turn divided into two sheathing layers 12a, 12b which differ in terms of their design. However, they are preferably made from the same material. In this variant embodiment, the sheathing material of the outer sheathing layer 12b has a multiplicity of hollow channels 14 passing through it. As illustrated in FIG. 3, these are preferably arranged completely around the circumference, wherein material webs between two adjacent hollow channels 14 for example have a smaller thickness compared to the diameter of the hollow channels 14.

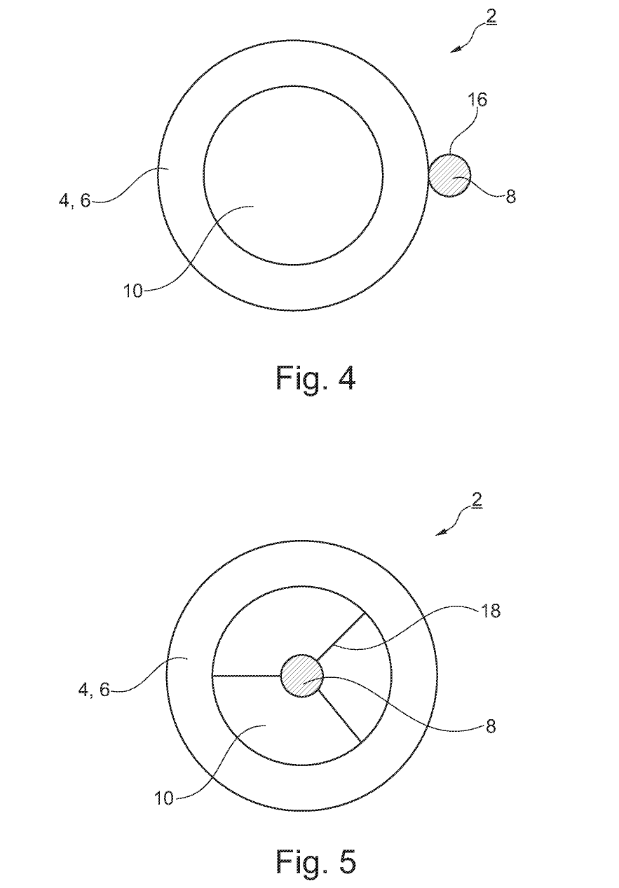

In the variant embodiment of FIG. 4, the heating element 8 is arranged on the outside of the sheathing 6. The heating wire here is covered by a sheathing skin 16 which is merely formed in the region of the heating element 8. As seen in cross section, the media guide 2 as a whole is therefore in the form of an eight.

The heating element 8 here is arranged in particular helically around the circumference of the sheathing 6.

Finally, in the variant embodiment according to FIG. 5, the heating element 8 is arranged in an interior space 10, and the heating element 8 here preferably extends precisely along a center axis of the media guide 2. The heating element 8 is also surrounded by the sheathing material here. The heating element 8 is held in a defined position in the interior space 10 here via at least one strut, and preferably a plurality of struts 18, which are likewise made from sheathing material. The struts 18 are therefore formed in the manner of wheel spokes. Three struts 18 are illustrated in the exemplary embodiment of FIG. 5.

In terms of the manufacturing technology, it is common to all of the variant embodiments that they are manufactured by an extrusion process in which the heating element 8 is further supplied in parallel with the hose extrusion of the sheathing 6 and is thereby at the same time surrounded by the sheathing material which is extruded to manufacture the sheathing 6 so that the heating element 8 is therefore also embedded in the sheathing material. This enables particularly economical manufacture of media guides 2 of this type without manual processing steps.

1. A heatable media guide for guiding a medium, the heatable media guide comprising:
a tubular guide element extending in a longitudinal direction and having a sheathing made from a sheathing material, said tubular guide element surrounding an interior space for the medium; and
at least one heating element extending with said sheathing in the longitudinal direction and is embedded in said sheathing material.

2. The media guide according to claim 1, wherein said sheathing is annularly shaped defining an annular sheathing and said heating element is embedded directly in said annular sheathing.

3. The media guide according to claim 1, wherein said sheathing has an inner sheathing layer and an outer sheathing layer and said outer sheathing layer has a greater thermal insulating effect compared to said inner sheathing layer.

4. The media guide according to claim 3, wherein said outer sheathing layer has a higher gas or air content than said inner sheathing layer.

5. The media guide according to claim 4, wherein said outer sheathing layer is a foamed sheathing layer.

6. The media guide according to claim 3, wherein said outer sheathing layer has hollow chambers incorporated therein, said hollow chambers are formed as hollow channels extending continuously in the longitudinal direction.

7. The media guide according to claim 3, wherein said heating element is disposed in said inner sheathing layer.

8. The media guide according to claim 1, wherein said heating element is embedded outside said sheathing in said sheathing material.

9. The media guide according to claim 8, wherein said heating element is guided along said outside of said sheathing and is surrounded to said outside by a sheathing skin made from said sheathing material.

10. The media guide according to claim 9, wherein said sheathing skin merely surrounds said heating element.

11. The media guide according to claim 1, wherein said heating element is disposed in said interior space and is connected and fixed to said sheathing via said sheathing material.

12. The media guide according to claim 11, further comprising at least one strut made from said sheathing material and held in said interior space at a spacing from said sheathing, said heating element is connected to said sheathing by said at least one strut.

13. The media guide according to claim 1, wherein said heating element is held centrally in said interior space.

14. A method for manufacturing a heatable media guide, which comprises the steps of:
extruding a sheathing surrounding an interior space for guiding a medium from a sheathing material resulting in a tubular guide element; and
during the extruding step, a heating element is supplied, which is surrounded by the sheathing material during the extruding of the sheathing, wherein the heating element:
is supplied directly to the sheathing; or
is supplied outside the sheathing; or
is supplied inside in the interior space and is embedded in each case in the sheathing material.

15. The method according to claim 14, which further comprises forming the sheathing in two layers including an inner sheathing layer and an outer sheathing layer having a greater thermal insulating effect than the inner sheathing layer.

16. The method according to claim 14, which further comprises supplying the heating element centrally in the interior space and a strut is formed which fixes the heating element on the sheathing, relative to the sheathing.

17. A method for guiding and tempering a medium, which comprises the steps of:
providing a heatable media guide containing a tubular guide element extending in a longitudinal direction and having a sheathing made from a sheathing material, the tubular guide element surrounding an interior space for the medium, and at least one heating element extending with the sheathing in the longitudinal direction and embedded in the sheathing material;
using the medium, being a reduction agent, for a selective catalytic reduction process; or
using the medium in food production, a mass which may be consumed by humans, is tempered by means of the heatable media guide to establish a desired viscosity.
